(19) United States
(12) Patent Application Publication
(10) Pub. No.: US 2019/0121185 A1
(43) Pub. Date: Apr. 25, 2019

(54) DISPLAY MOTHER PANEL AND DISPLAY PANEL

(71) Applicant: Chunghwa Picture Tubes, LTD., Taoyuan City (TW)

(72) Inventors: Kan-Ju Liu, Taoyuan City (TW); Yi-Fen Su, Taoyuan City (TW); Chih-Chuan Chen, Taoyuan City (TW)

(73) Assignee: Chunghwa Picture Tubes, LTD., Taoyuan City (TW)

(21) Appl. No.: 15/842,880

(22) Filed: Dec. 15, 2017

(30) Foreign Application Priority Data
Oct. 23, 2017 (CN) 201721364776.7

(51) Int. Cl. G02F 1/1339; G02F 1/1335; G02F 1/1333

(52) U.S. Cl. CPC G02F 1/13394; G02F 1/133512; G02F 2001/13396; G02F 1/133514; G02F 1/133345

(57) ABSTRACT

A display mother panel including a first motherboard, a second motherboard, a plurality of sealant structures and a plurality of spacers is provided. The second motherboard is stacked over the first motherboard. The sealant structures are disposed between the first motherboard and the second motherboard. An area surrounded by each of the sealant structures includes a display region and a non-display region surrounding the display region, and a peripheral region is between two adjacent sealant structures. The spacers are disposed on a lower surface of the second motherboard which is relatively close to the first motherboard and at least located in the non-display region and the peripheral region. The display mother panel can provide preferable structure reliability and display quality. Moreover, each display panel made from the display mother panel is also provided.

### CROSS-REFERENCE TO RELATED APPLICATION

This application claims the priority benefit of China application serial no. 201721364776.7, filed on Oct. 23, 2017. The entirety of the above-mentioned patent application is hereby incorporated by reference herein and made a part of this specification.

### BACKGROUND

### Field of the Invention

The invention is directed to a display mother panel and a display panel and more particularly, to a display mother panel and a display panel having a plurality of spacers in a non-display region and a peripheral region.

### Description of Related Art

In recent years, as electronic apparatuses have been developed toward a trend of miniaturization, display panels also have to be light and thin for satisfying demands for portability of terminal products. As for current techniques, in order to save cost and to integrate manufacturing processes, a large-size display mother panel is first manufactured. The large-size display mother panel includes, for example, a plurality of display panel units manufactured on a large-size substrate, and the display mother panel are cut, such that the display panel units are split into a plurality of independent display panels.

When the display mother panel are cut into the display panels, a region near to where the display mother panel is cut is subject to factors, such as a force (e.g., a cutting stress) or poor flatness of the substrate, such that issues such as tilting edges and peeling-off at corners may occur to the region close to where the display mother panel is cut on the substrate, which would lead to poor appearance of the display panels unevenness of cell gaps of an overall display medium and then, lead to a phenomenon, for example, a defect of chromatic aberration appearing to peripheral regions of the display panels at the product end. Specially, such phenomenon may be worsened to miniaturized display panels.

### SUMMARY

The invention provides a display mother panel having preferable structure reliability and display quality.

The invention provides a display panel having preferable evenness of cell gaps of a display medium.

A display mother panel of the invention includes a first motherboard, a second motherboard, a plurality of sealant structures and a plurality of spacers. The second motherboard is stacked over the first motherboard. The sealant structures are disposed between the first motherboard and the second motherboard. An area surrounded by each of the sealant structures includes a display region and a non-display region surrounding the display region, and a peripheral region is between two sealant structures. The spacers are disposed on a lower surface of the second motherboard which is relatively close to the first motherboard and at least located in the non-display region and the peripheral region.

In an embodiment of the invention, the display mother panel further includes a black matrix (BM) layer, an over coat (OC) layer and a color filter (CF) layer. The BM layer is disposed on the lower surface of the second motherboard. The OC layer is disposed between the BM layer and the spacers. The BM layer and the OC layer are located in the display region, the non-display region and the peripheral region. The CF layer is disposed between the BM layer and the OC layer and at least located in the display region.

In an embodiment of the invention, each of the spacers includes a main spacer and a sub spacer with a space from the main spacer, wherein the main spacer has a first height protruding from the second motherboard toward one side of the first motherboard, the sub spacer has a second height protruding from the second motherboard toward the one side of the first motherboard, and the first height is greater than the second height.

In an embodiment of the invention, the display mother panel further includes a first CF layer located in the non-display region and the peripheral region, the sub spacer includes a first sub spacer and a second sub spacer, and the first sub spacer is disposed corresponding to the first CF layer, wherein a first vertical distance is between an end of the main spacer and an upper surface of the first motherboard which is relatively close to the second motherboard, a second vertical distance is between an end of the first sub spacer and the upper surface, a third vertical distance between an end of the second sub spacer and the upper surface, the first vertical distance is less than the second vertical distance, and the second vertical distance is less than the third vertical distance.

In an embodiment of the invention, the display mother panel further comprises a pad layer located on the upper surface of the first motherboard in the non-display region and the peripheral region, the sub spacer includes a first sub spacer and a second sub spacer, and the first sub spacer is disposed corresponding and opposite to the pad layer wherein a first vertical distance is between an end of the main spacer and the upper surface of the first motherboard which is relatively close to the second motherboard, a second vertical distance is between an end of the first sub spacer and the pad layer, a third vertical distance is between an end of the second sub spacer and the upper surface, the first vertical distance is less than the second vertical distance, and the second vertical distance is less than the third vertical distance.

A display panel of the invention includes a first substrate, a second substrate, a sealant structure and a plurality of spacers. The second substrate is disposed opposite to the first substrate. The sealant structure is disposed between the first substrate and the second substrate. An area surrounded by the sealant structure comprises a display region and a non-display region surrounding the display region, and a region outside the area surrounded by the sealant structure is a peripheral region. The spacers are disposed on a lower surface of the second substrate which is relatively close to the first substrate and at least located in the non-display region and the peripheral region.

In an embodiment of the invention, the display panel further includes a BM layer, an OC layer and a CF layer. The BM layer is disposed on the lower surface of the second substrate The OC layer is disposed between the BM layer and the spacers, wherein the BM layer and the OC layer are located in the display region, the non-display region and the peripheral region. The CF layer is disposed between the BM layer and the OC layer and at least located in the display region.

In an embodiment of the invention, each of the spacers includes a main spacer and a sub spacer disposed with a space from each main spacer, wherein the main spacer has a first height protruding from the second substrate toward one side of the first substrate, the sub spacer has a second height protruding from the second substrate toward the one side of the first substrate, and the first height is greater than the second height.

In an embodiment of the invention, the display panel further includes a first CF layer located in the non-display region and the peripheral region, the sub spacer includes a first sub spacer and a second sub spacer, the first sub spacer is disposed corresponding to the first CF layer, wherein a first vertical distance is between an end of the main spacer and an upper surface of the first substrate which is relatively close to the second substrate, a second vertical distance is between and an end of the first sub spacer and the upper surface, a third vertical distance is between an end of the second sub spacer and the upper surface, the first vertical distance is less than the second vertical distance, and the second vertical distance is less than the third vertical distance.

In an embodiment of the invention, the display panel further includes a pad layer located on the upper surface of the first substrate in the non-display region and the peripheral region, the sub spacers includes a first sub spacer and a second sub spacer, and the first sub spacer is disposed corresponding and opposite to the pad layer, wherein a first vertical distance is between an end of the main spacer and the upper surface of the first substrate which is relatively close to the second substrate, a second vertical distance is between an end of the first sub spacer and the pad layer, a third vertical distance is between an end of the second sub spacer and the upper surface, the first vertical distance is less than the second vertical distance, and the second vertical distance is less than the third vertical distance.

Based on the above, the display mother panel includes the spacers disposed on the lower surface of the second motherboard which is relatively close to the first motherboard and at least located in the non-display region and the peripheral region. In this way, the region near where the first motherboard and the second motherboard of the display mother panel are cut can be prevented from phenomena such as tilting edges and peeling-off at corners generated by the stress during cutting, and evenness of cell gaps of the display medium between the first substrate and the second substrate of each cut display panel can be maintained, which contributes to preferable structure reliability and display quality for the display panels of terminal products.

### BRIEF DESCRIPTION OF THE DRAWINGS

FIG. 1A is a schematic top view of a display mother panel according to an embodiment of the invention.

FIG. 1B is a cross-sectional view of the display mother panel depicted in FIG. 1A along a line A-A′.

FIG. 1C is a schematic cross-sectional view of a display panel obtained after the display mother panel depicted in FIG. 1B is cut along a predetermined cutting line C.

FIG. 1D is a schematic top view of a display mother panel according to another embodiment of the invention.

FIG. 1E is another cross-sectional view of the display mother panel depicted in FIG. 1A along the line A-A′.

FIG. 2A to FIG. 2C are schematic top views of display mother panels according to different embodiments of the invention.

### DESCRIPTION OF EMBODIMENTS

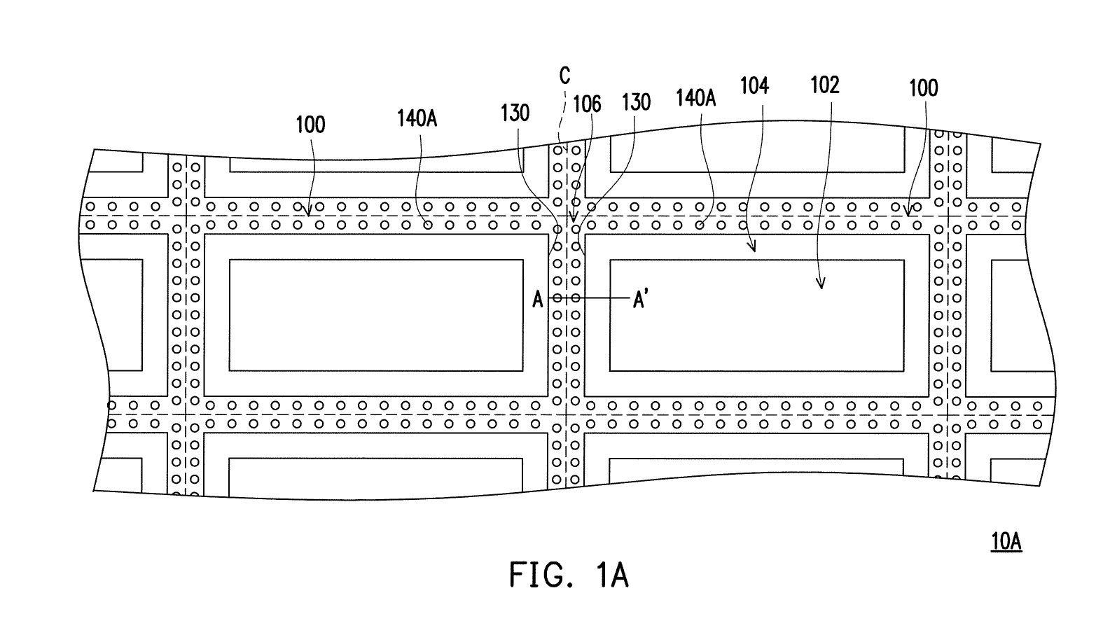

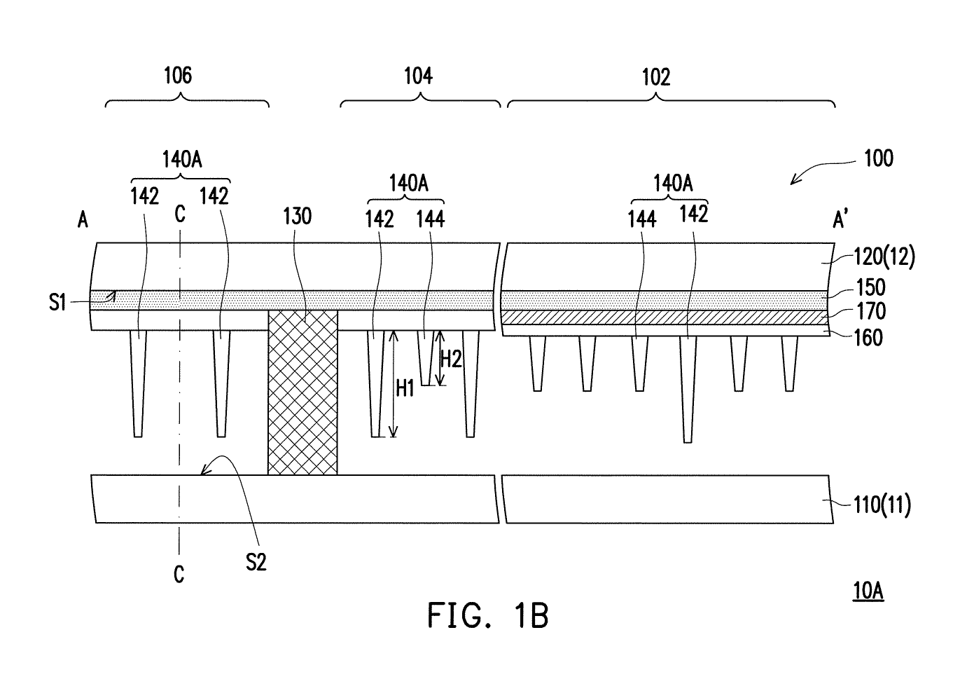

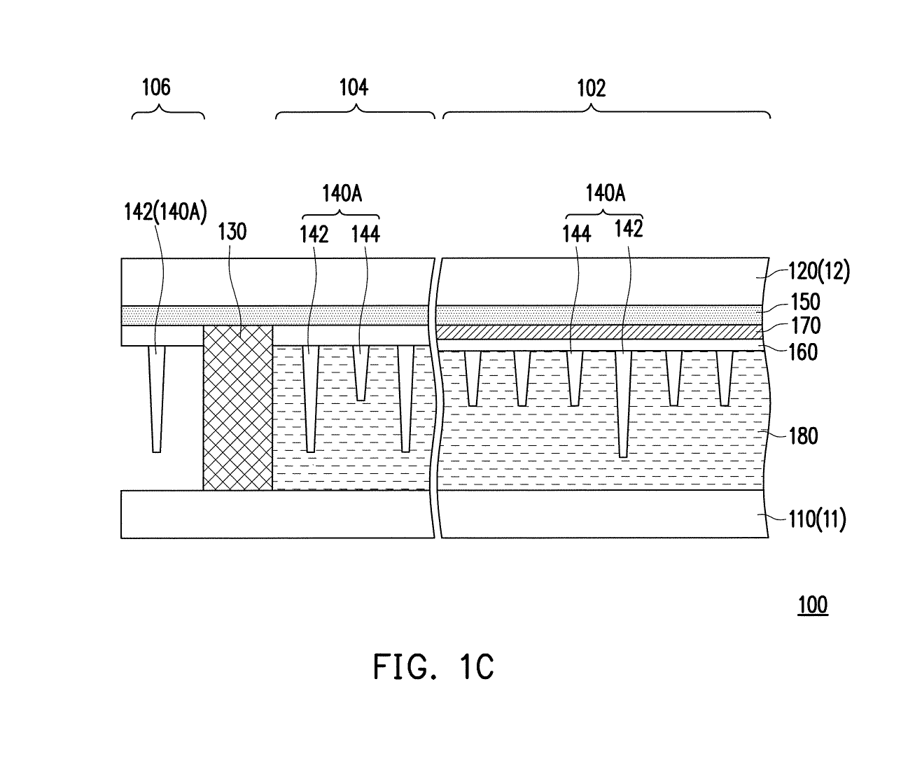

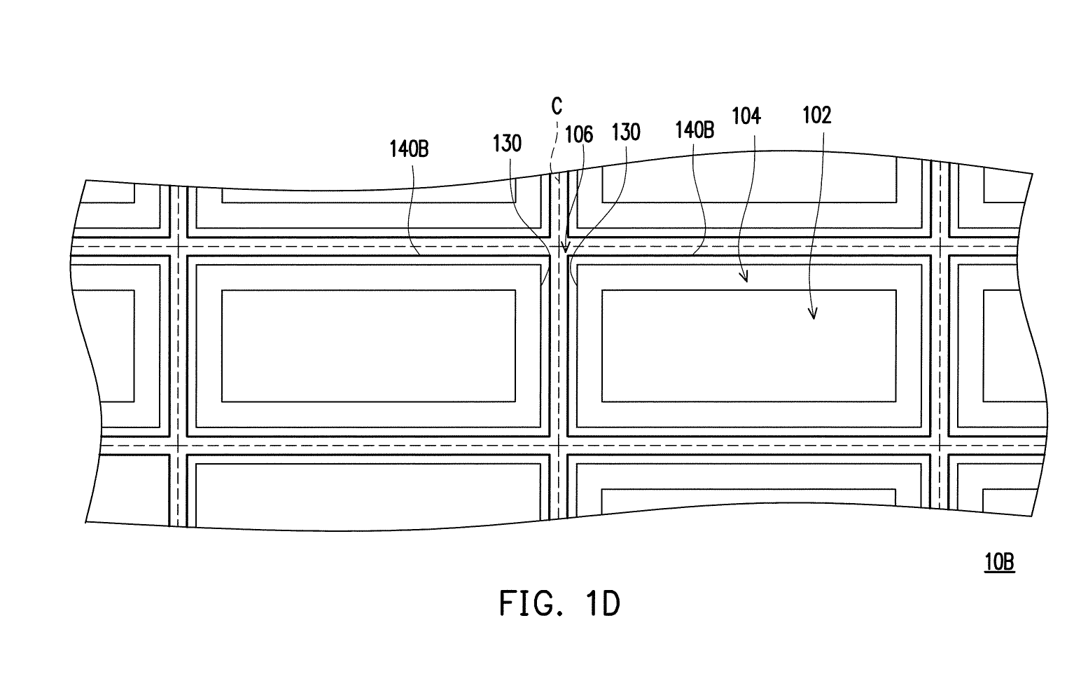

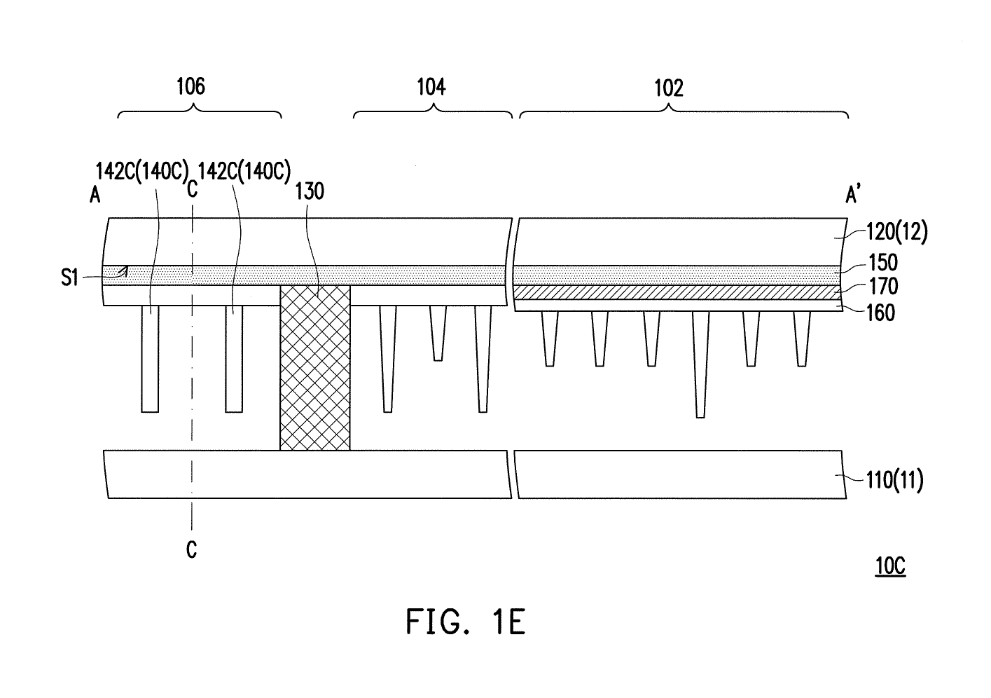

First, referring to FIG. 1A to FIG. 1B simultaneously, a display mother panel 10A includes a first motherboard 11, a second motherboard 12, a plurality of sealant structures 130 and a plurality of spacers 140A. The second motherboard 12 is stacked over the first motherboard 11. The sealant structures 130 are disposed between the first motherboard 11 and the second motherboard 12. The spacers 140A are disposed on a lower surface S1 of the second motherboard 12 which is relatively close to the first motherboard 11.

Specifically, the first motherboard 11 and the second motherboard 12 are disposed opposite to each other. The first motherboard 11 and the second motherboard 12 may include rigid substrates or flexible substrates and may be made of, for example, glass, quartz, an organic polymer, a non-transparent/reflective material (e.g., wafer or ceramic) or other materials adaptive for bearing elements. The sealant structures 130 are located between the first motherboard 11 and the second motherboard 12, such that the first motherboard 11 and the second motherboard 12 are adhered to each other, and the first motherboard 11 and the second motherboard 12 are supported by the sealant structures 130 therebetween. A material of the sealant structures 130 may include, for example, a photo-curable material, thermosetting material or other adaptive curable materials, and is capable of providing preferable bonding capacity and reliability between the first motherboard 11 and the second motherboard 12 and preventing a display medium between the first motherboard 11 and the second motherboard 12 from being polluted. A top-view contour of each of the sealant structures 130 presents a ring shape. An area surrounded by each of the sealant structures 130 may be divided into a display region 102 and a non-display region 104 surrounding the display region 102, and a peripheral region 106 is between two adjacent sealant structures 130.

The spacers 140A are at least located in the non-display region 104 and the peripheral region 106, and a portion of the spacers 140A may be further located in the display region 102. Taking the present embodiment for example, each of the spacers 140A includes a main spacer 142 and a sub spacer 144 disposed with a space from each other. The main spacers 142 may be located in the display region 102, the non-display region 104 and the peripheral region 106, and the sub spacers 144 may be located in the display region 102 and the non-display region 104, but the invention is not limited thereto. In other embodiments, a portion of the sub spacers 144 may be disposed in the peripheral region 106. The main spacer 142 has a first height H1 protruding from the second motherboard 12 toward one side of the first motherboard 11, the sub spacer 144 has a second height H2 protruding from the second motherboard 12 toward the one side of the first motherboard 11, and the first height H1 is greater than the second height H2. In other words, the main spacer 142 and the sub spacer 144 are differentiated from each other according to the heights of the spacers. In this case, a material of the spacers 140A may include, for example, polymer material such as a positive photoresist material or a negative photoresist material, but the invention is not limited thereto.

In the present embodiment, the main spacers 142 located in the display region 102, the non-display region 104 and the peripheral region 106 have the same height and are made of the same material, the sub spacers 144 located in the display region 102, and the non-display region 104 and the peripheral region 106 have the same height and are made of the same material. Thus, all the spacers 140A may be manufactured by adopting the same manufacturing steps, without region-divisionally adopting different manufacturing steps. Further, the main spacers 142 and/or the sub spacers 144 located in the display region 102, the non-display region 104 and the peripheral region 106 in a condition that no force is applied thereto may not contact the first motherboard 11. When the display mother panel 10A is pressed, the spacers 140A are capable of adaptively buffering and maintaining a spacing distance between the first motherboard 11 and the second motherboard 12.

Continuing to refer to FIG. 1B, in the present embodiment, the display mother panel 10A further includes a black matrix (BM) layer 150, an over coat (OC) layer 160 and a color filter (CF) layer 170. The BM layer 150, the CF layer 170 and the OC layer 160 are sequentially disposed on the lower surface S1 of the second motherboard 12 and located between the second motherboard 12 and the spacers 140A. The BM layer 150 is disposed on the lower surface S1 of the second motherboard 12, the OC layer 160 is disposed between the BM layer 150 and the spacers 140A, and the CF layer 170 is disposed between the BM layer 150 and the OC layer 160. Even though FIG. 1B illustrates that the BM layer 150 and the OC layer 160 are located in the display region 102, the non-display region 104 and the peripheral region 106, and the CF layer 170 is located in the display region 102, but the regions where these elements are disposed are not limited thereto. In this case, a material of the BM layer 150 may include, for example, a black resin, an organic light-shielding material or other adaptive light-shielding materials, a material of the CF layer 170 may include, for example, a color resin or other adaptive materials, and a material of the OC layer 160 may include, for example, an epoxy resin, an acrylic resin or other polymer materials, but the invention is not limited thereto.

As the CF layer 170 is between the spacers 140A in the display region 102 and the second motherboard 12, but not be between the spacers 140A located in the non-display region 104 and the second motherboard 12 and not be between the spacers 140A located in the peripheral region 106 and the second motherboard 12, the OC layer 160 may have a surface with slightly different heights in the display region 102 and in the non-display region 104 and the peripheral region 106. The different heights vary with a thickness of the CF layer 170 disposed above the second motherboard 12. In this circumstance, an end of the main spacer 142 located in the display region 102 may be closer to the first motherboard 11 than an end of the main spacer 142 located in the non-display region 104. However, in other embodiments which are not shown, the OC layer 160 may also increase flatness of an overall surface of a color filter substrate.

Then, referring to FIG. 1A to FIG. 1C, it should be mentioned first herein that predetermined cutting lines C are respectively set in the peripheral region 106 of the first motherboard 11 and the second motherboard 12 of the display mother panel 10A between any two adjacent sealant structures 130. For the display mother panel 10A, the first motherboard 11 may be cut into a plurality of first substrates 110 along the predetermined cutting line C, and the second motherboard 12 may be cut into a plurality of second substrates 120 along the predetermined cutting line C, thereby forming display panels 100 as illustrated in FIG. 1C. In other words, the display mother panel 10A actually includes a plurality of display panels 100 connected with one another and arranged in an array. Each of the first substrates 110 and each of the second substrates 120 are assembled together through a sealant structure 130, and a display medium 180 fills an area surrounded by each of the sealant structures 130, thereby forming a single display panel 100. In this case, the display medium 180 may include an electrophoretic display medium, a liquid crystal display medium or an electro-wetting display medium, which is not limited in the invention. It is to be mentioned that depending on process variations and/or design requirements, the display medium 180 may fill before or after the display mother panel 10A being cut into the display panels 100, but a manner and a timing for filling the display medium 180 in the display panel 10A are not limited in the invention. Up to here, the display panel 100 provided by the invention is substantially completed.

To be detailed, when a force is applied along the predetermined cutting line C in the peripheral region 106 of the display mother panel 10A to cut the first motherboard 11 and the second motherboard 12, the first motherboard 11 and the second motherboard 12, due to a cutting stress, are deformed, e.g., bent, when being cut. In this circumstance, a buffering effect is provided, such that a bending and deformation degree of the first motherboard 11 and the second motherboard 12 is restricted. Thus, after the first motherboard 11 and the second motherboard 12 are cut into the first substrates 110 and the second substrates 120, phenomena, such as tilting edges and peeling-off at corners, may be prevented from occurring to the first substrates 110 and the second substrates 120 near the sealant structures 130, which contributes to increasing process yield of the display panels 100. Furthermore, each of the spacers 140A in the non-display region 104 includes a main spacer 142 and a sub spacer 144 with different heights for providing multi-section buffering.

When the cutting stress (which is not shown) is applied to the display mother panel 10A along the predetermined cutting line C to cut the first motherboard 11 and the second motherboard 12, the first motherboard 11 and the second motherboard 12 get close toward each other by the cutting stress. In this circumstance, the main spacer 142 located in the non-display region 104, due to having a greater height, contacts the upper surface S2 of the first motherboard 11 prior to the sub spacer 144. When the cutting stress continues to be applied, the main spacer 142 is pressed, which causes the sub spacer 144 to contact the upper surface S2 of the first motherboard 11. In this way, the main spacer 142 and the sub spacer 144 provided by the present embodiment, due to having different heights from each other, capable of providing multi-section buffering between the first motherboard 11 and the second motherboard 12 when the display mother panel 10A is cut.

Continuing to refer to FIG. 1C, as the display panel 100 formed by cutting the display mother panel 10A includes a first substrate 110, a second substrate 120, a sealant structure 130 and spacers 140A. The second substrate 120 and the first substrate 110 are disposed opposite to each other. The sealant structure 130 is disposed between the first substrate 110 and the second substrate 120. The spacers 140A are disposed on the lower surface S1 of the second substrates 120 which is relatively close to the first substrate 110. In addition, the display panel 100 of the present embodiment further includes a display medium 180. An area surrounded by the sealant structure 130 includes a display region 102 and a non-display region 104 surrounding the display region 102, and a peripheral region 106 is outside the area surrounded by the sealant structure 130. Even though the display medium 180 may fill the entire area surrounded by the sealant structure 130, in the present embodiment, the area surrounded by the sealant structure 130 may still be divided into the display region 102 and the non-display region 104. The display region 102 and the non-display region 104 may be defined by using a range of a region of the display panel 100 which is capable of displaying an image. For instance, the display panel 100, when being applied in an electronic apparatus, may be assembled to a housing of the electronic apparatus. In this circumstance, the display region 102 may be considered as a region surrounded by the housing of the electronic apparatus for displaying the image. In other embodiments, the display panel 100 may include a plurality of pixel structures (which are not shown), a distribution region of the pixel structures may be considered as the display region 102, and a region between the pixel structures and the sealant structure 130 may be considered as the non-display region 104. The peripheral region 106 may be considered as a region from an outer edge of the sealant structure 130 to an edge of the display panel 100, and at least a portion of the spacers 140A of the present embodiment are located in the non-display region 104 and the peripheral region 106.

In this case, the first substrate 110 cut from the first motherboard 11 may serve as an active array substrate, on which a plurality of elements, such as thin film transistors (TFTs) and signal lines, respectively distributed in an array may be disposed. The first substrate 110 is configured to electrically drive the display medium 180 (as illustrated in FIG. 1C) in the display panel 100 to achieve the function of displaying images. However, in other embodiments which are not shown, the first substrate 110 may also be, for example, a passive array substrate or any other array substrate with operation circuits, which is not limited herein. The second substrate 120 cut from the second motherboard 12 may be a color filter substrate, on which elements, such as a BM layer, a CF layer, an OC layer and a ITO conductive film, may be disposed. Display light may pass through the CF layer to form a color display image, but the invention is not limited thereto. Structures and selection of materials with respect to the active array substrate and the color filter substrate are well known in this field, less essential to the invention, and thus, will not be described any further.

In FIG. 1A, top-view contours of the spacers 140A in the peripheral region 106 may be, for example, discontinuous dotted-structure patterns. Namely, each of the spacers 140A of the display mother panel 10A in the peripheral region 106 has a striped structure. In other embodiments, as illustrated in FIG. 1D, top-view contours of a plurality of spacers 140B of a display mother panel 10B in the peripheral region 106 may be continuous patterns in a ring structure. That is, each of the spacers 140B of the display mother panel 10B in the peripheral region 106 has a blocking-wall (plate) structure. In addition, in FIG. 1B, a sectional contour of each of the spacers 140A in the display region 102, the non-display region 104 and the peripheral region 106 may be a trapezoidal structure, in which a surface area of one end of the spacer 140A close to the second motherboard 12 is greater than a surface area of the other end relatively far away from the second motherboard 12, but the invention is not limited thereto. In other embodiments, as illustrated in FIG. 1E, a sectional contour of a main spacer 142C of each spacer 140C of a display mother panel IOC in the peripheral region 106 may be a rectangular structure. That is, a surface area of one end of the spacer 140C close to the second motherboard 12 is substantially equal to a surface area of the other end relatively far away from the second motherboard 12. However, in other embodiments which are not shown, the top-view contour and the sectional contour of each spacer may be adaptively adjusted based on actual product requirements. The spacers, as long as being distributed in the non-display region and the peripheral region of the display mother panel and provides the buffering effect when the display mother panel is pressed by a force or is cut, fall within the scope of the invention, and the shape and the number of the spacers are not particularly limited in the invention.

It should be noted that, in the embodiment described below, element labels and portions of the previous embodiments are referenced hereafter, and the same or similar elements are indicated by the same or similar reference labels. The descriptions of the same technical details are therefore not repeated here. The parts omitted from description may be referenced from the afore-described embodiments and are not repeated in the embodiment below.

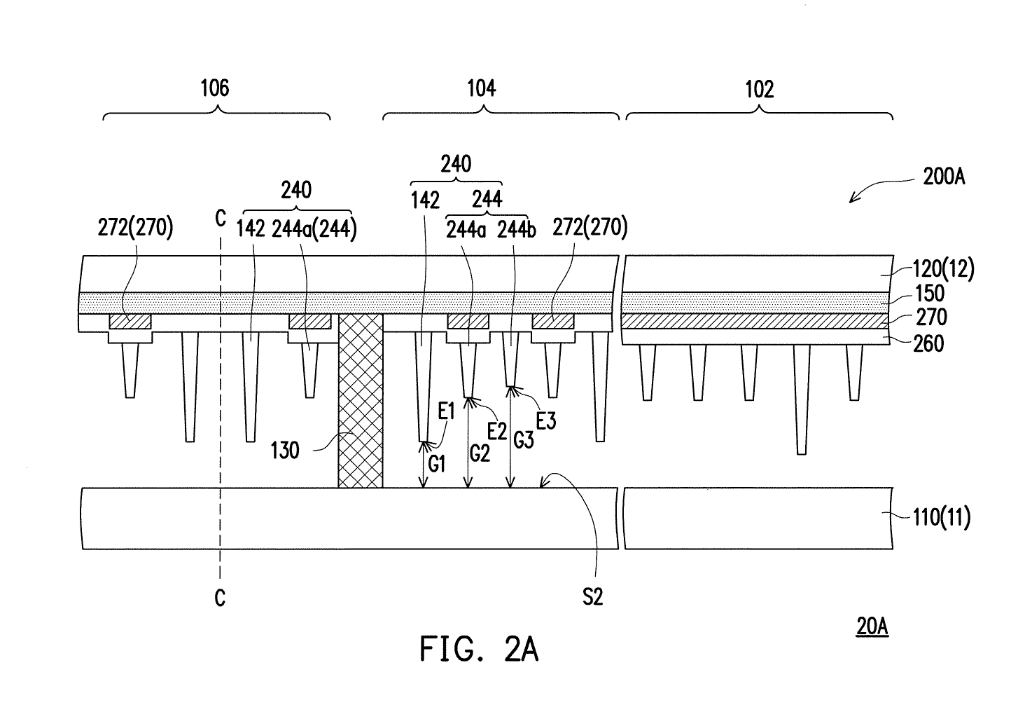

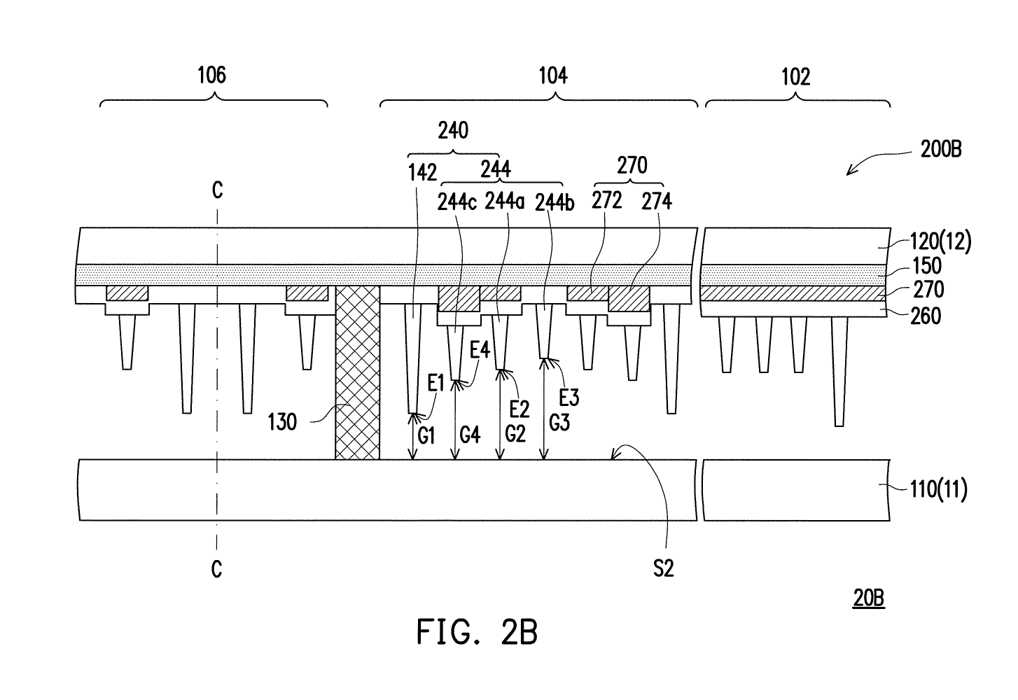

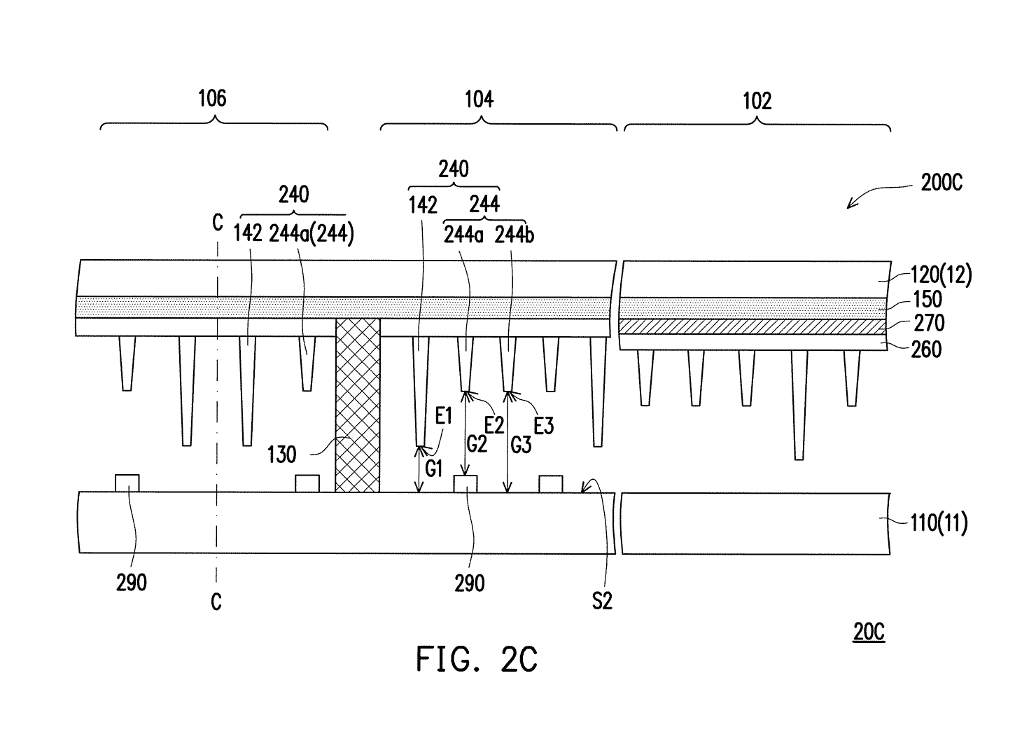

FIG. 2A is a schematic top view of a display mother panel according to another embodiment of the invention. Referring to both FIG. 1B and FIG. 2A, a display mother panel 20A of the present embodiment is similar to the display mother panel 10A illustrated in FIG. 1B, and thus, the same or the like parts are labeled by the same or the like reference numbers. Specifically, the display mother panel 20A has a display region 102, a non-display region 104 surrounding the display region 102 and a peripheral region 106 surrounding the display region 102 and the non-display region 104. The display mother panel 20A includes a first motherboard 11, a second motherboard 12, a plurality of sealant structures 130, a plurality of spacers 240, a BM layer 150, an OC layer 260 and a CF layer 270. Disposition relations and effects of the first motherboard 11, the second motherboard 12, the sealant structures 130 and the BM layer 150 and effects of the spacers 240, the OC layer 260 and the CF layer 270 may refer to the detailed description related to the embodiment illustrated in FIG. 1B and will not be repeated. The difference between the two embodiments lies in the CF layer 270 of the display mother panel 20A of the present embodiment further including a first CF layer 272 located in the non-display region 104 and the peripheral region 106, where the OC layer 260 conformally covers the first CF layer 272. In addition, each of the spacers 240 further include a main spacer 142 and a sub spacer 244, and the sub spacer 244 includes a first sub spacer 244a and a second sub spacer 244b. The first sub spacer 244a and the second sub spacer 244b have the same height, and the first sub spacer 244a is disposed corresponding to the first CF layer 272, but the second sub spacer 244b is not so disposed.

In the present embodiment, the OC layer 260 covers the CF layer 270, and the OC layer 260 undulate along with the CF layer 270. Thus, a first vertical distance G1 is between an end E1 of the main spacer 142 and an upper surface S2 of the first motherboard 11 which is relative close to the second motherboard 12, a second vertical distance G2 is between an end E2 of the first sub spacer 244a and the upper surface S2, and a third vertical distance G3 is between an end E3 of the second sub spacer 244b and the upper surface S2. The first vertical distance G1 is less than the second vertical distance G2, and the second vertical distance G2 is less than the third vertical distance G3. Thus, when the step of cutting along the predetermined cutting line C is performed to cut the display mother panel 20A into display panels 200A, the main spacers 142, the first sub spacers 244a and the second sub spacers 244b may be capable of providing multi-section buffering, thereby preventing issues, such as collapse at edges or corners and unevenness of cell gaps from occurring to the display panel 200A.

FIG. 2B is a schematic top view of a display mother panel according to another embodiment of the invention. Referring to both FIG. 2A and FIG. 2B, a display mother panel 20B of the present embodiment is similar to the display mother panel 20A illustrated in FIG. 2A, and thus, the same or the like parts are labeled by the same or the like reference numbers. Specifically, the display mother panel 20B has a display region 102, a non-display region 104 surrounding the display region 102 and a peripheral region 106 surrounding the display region 102 and the non-display region 104. The display mother panel 20B includes a first motherboard 11, a second motherboard 12, a plurality of sealant structures 130, a plurality of spacers 240, a BM layer 150, an OC layer 260 and a CF layer 270. Disposition relations and effects of the first motherboard 11, the second motherboard 12, the sealant structures 130 and the BM layer 150 and effects of the spacers 240, the OC layer 260 and the CF layer 270 may refer to the detailed description related to the embodiment illustrated in FIG. 2A and will not be repeated hereinafter. The difference between the two embodiments lies in the CF layer 270 of the display mother panel 20B further including a second CF layer 274 located in the non-display region 104, and the sub spacer 244 further including a third sub spacer 244c, and the third sub spacer 244c being disposed corresponding to the second CF layer 274 and located in the non-display region 104, where a fourth vertical distance G4 between an end E4 of the third sub spacer 244c and the upper surface S2 of the first motherboard 11, and the fourth vertical distance G4 is greater than the first vertical distance G1, less than the second vertical distance G2 and less than the third vertical distance G3. In this case, a thickness of the second CF layer 274 is greater than a thickness of the first CF layer 272. For example, the thickness of the second CF layer 274 is twice the thickness of the first CF layer 272, but the invention is not limited thereto.

Specifically, regarding the spacers 240 of the display mother panel 20B in the non-display region 104 of the present embodiment, the main spacer 142, the third sub spacer 244c, the first sub spacer 244a and the second sub spacer 244b are sequentially disposed in a direction from the sealant structure 130 toward the display region 102, and distances respectively from the end E1 of the main spacer 142, the end E4 of the third sub spacer 244c, the end E2 of the first sub spacer 244a and the end E3 of the second sub spacer 244b to the upper surface S2 of the first motherboard 11 are gradually increased, such that the display mother panel 20B, when being cut into the display panels 200B along the predetermined cutting line C, may achieve a preferable buffering effect, thereby preventing issues, such as collapse at edges or corners and unevenness of cell gaps from occurring to the display panels 200B.

FIG. 2C is a schematic top view of a display mother panel according to another embodiment of the invention. Referring to both FIG. 1B and FIG. 2C, a display mother panel 20C of the present embodiment is similar to the display mother panel 10A illustrated in FIG. 1B, and thus, the same or the like parts are labeled by the same or the like reference numbers. Specifically, the display mother panel 20C has a display region 102, a non-display region 104 surrounding the display region 102 and a peripheral region 106 surrounding the display region 102 and the non-display region 104. The display mother panel 20C includes a first motherboard 11, a second motherboard 12, a plurality of sealant structures 130, a plurality of spacers 240, a BM layer 150, an OC layer 260 and a CF layer 270. Disposition relations and effects of the first motherboard 11, the second motherboard 12, the sealant structures 130, the BM layer 150, the OC layer 260 and the CF layer 270 and effects of the spacers 240 may refer to the detailed description related to the embodiment illustrated in FIG. 1B and will not be repeated hereinafter. The difference between the two embodiments lies in the display mother panel 20C of the present embodiment further including a pad layer 290 located on the upper surface S2 of the first motherboard 11 in the non-display region 104 and the peripheral region 106. Each of the sub spacers 244 includes a first sub spacer 244a and a second sub spacer 244b, the first sub spacer 244a is disposed corresponding and opposite to the pad layer 290, and the second sub spacer 244b is not disposed opposite to the pad layer 290. A first vertical distance G1 is between an end E1 of the main spacer 142 and the upper surface S2 of the first motherboard 11 which is relatively close to the second motherboard 12, a second vertical distance G2 is between an end E2 of the first sub spacer 244a and the pad layer 290, and a third vertical distance G3 is between an end E3 of the second sub spacer 244b and the upper surface S2. The first vertical distance G1 is less than the second vertical distance G2, and the second vertical distance G2 is less than the third vertical distance G3.

In the present embodiment, the pad layer 290 contacts the upper surface S2 of the first motherboard 11, and the main spacer 142, the first sub spacer 244a and the second sub spacer 244b are located on one side of the second motherboard 12 which is relatively close to the first motherboard 11 in the non-display region 104. The main spacer 142 and the first sub spacer 244a are located on one side of the second motherboard 12 which is relatively close to the first motherboard 11 in the peripheral region 106. The first sub spacer 244a and the second sub spacer 244b have the same height, and the first sub spacer 244a is disposed corresponding to the pad layer 290, such that the first sub spacers 244a and the second sub spacers 244b, when being pressed, have different buffering effects, thereby preventing issues, such as collapse at edges or corners and unevenness of cell gaps from occurring to the display panel 200C, when being cut into the display panels 200C along the predetermined cutting line C. In this case, a material of the pad layer 290 may include, for example, metal, alloy or other adaptive conductive materials, but the invention is not limited thereto.

It should be noted that besides the applications and the modifications of the embodiment described above, in other embodiments which are not shown, persons skilled in the art may also adaptively and alternatively use the aforementioned elements, such as the BM layer, the CF layer, the OC layer and the pad layer to achieve more aspects of the height difference and the buffering effects of the spacers in the non-display region and the peripheral region.

In addition, although in the embodiments described above, the sub spacers 144 and 244, the first sub spacers 244a, the second sub spacers 244b and/or the third sub spacers 244c have the same vertical height, but two ends of each of the sub spacers 144 and 244 contact different materials, the first sub spacer 244a, the second sub spacer 244b and the third sub spacer 244c, when being pressed by a force (e.g., the cutting stress) have different buffering effects, and the display mother panels 10A, 10B, 10C, 20A, 20B and 20C, when being pressed by the cutting stress, are capable of multi-section buffering, thereby preventing an issue of peripheral chromatic aberration resulted from unevenness of cell gaps of the display panels 100, 200A, 200B and 200C from occurring to the display panels 100, 200A, 200B and 200C.

In light of the foregoing, the display mother panel and the display panel of the invention includes the spacers located in the non-display region and the peripheral region. In this way, the phenomena, such as tilting edges and collapse at corners can be prevented from occurring to the region near where the first motherboard and the second motherboard of the display mother panel are cut, and evenness of cell gaps of the display medium between the first substrate and the second substrate of each cut display panel can be maintained, which contributes to preferable structure reliability and display quality for the display panels of terminal products.

What is claimed is:

1. A display mother panel, comprising:
a first motherboard;
a second motherboard, stacked over the first motherboard;
a plurality of sealant structures, disposed between the first motherboard and the second motherboard, wherein an area surrounded by each of the plurality of sealant structures comprises a display region and a non-display region surrounding the display region, and a peripheral region is between two adjacent sealant structures; and
a plurality of spacers, disposed on a lower surface of the second motherboard which is relatively close to the first motherboard and at least located in the non-display region and the peripheral region.

2. The display mother panel according to claim 1, further comprising:
a black matrix layer, disposed on the lower surface of the second motherboard;
an over coat layer, disposed between the black matrix layer and the plurality of spacers, wherein the black matrix layer and the over coat layer are located in the display region, the non-display region and the peripheral region; and
a color filter layer, disposed between the black matrix layer and the over coat layer and at least located in the display region.

3. The display mother panel according to claim 1, wherein each of the plurality of spacers comprises a main spacer and a sub spacer disposed with a space from the main spacer, wherein the main spacer has a first height protruding from the second motherboard toward one side of the first motherboard, the sub spacer has a second height protruding from the second motherboard toward the one side of the first motherboard, and the first height is greater than the second height.

4. The display mother panel according to claim 3, further comprising: a first color filter layer located in the non-display region and the peripheral region, and the sub spacer comprising a first sub spacer and a second sub spacer, and the first sub spacer being disposed corresponding to the first color filter layer, wherein a first vertical distance is between an end of the main spacer and an upper surface of the first motherboard which is relatively close to the second motherboard, a second vertical distance is between an end of the first sub spacer and the upper surface, a third vertical distance is between an end of the second sub spacer and the upper surface, the first vertical distance is less than the second vertical distance, and the second vertical distance is less than the third vertical distance.

5. The display mother panel according to claim 3, further comprising:
a pad layer, located on an upper surface of the first motherboard in the non-display region and the peripheral region, the sub spacer comprising a first sub spacer and a second sub spacer, and the first sub spacer being disposed corresponding and opposite to the pad layer, wherein a first vertical distance is between an end of the main spacer and the upper surface of the first motherboard which is relatively close to the second motherboard, a second vertical distance is between an end of the first sub spacer and the pad layer, a third vertical distance is between an end of the second sub spacer and the upper surface, the first vertical distance is less than the second vertical distance, and the second vertical distance is less than the third vertical distance.

6. A display panel, comprising:
a first substrate;
a second substrate, disposed opposite to the first substrate;
a sealant structure, disposed between the first substrate and the second substrate, wherein an area surrounded by the sealant structure comprises a display region and a non-display region surrounding the display region, and a region outside the area surrounded by the sealant structure is a peripheral region; and
a plurality of spacers, disposed on a lower surface of the second substrate which is relatively close to the first substrate and at least located in the non-display region and the peripheral region.

7. The display panel according to claim 6, further comprising:
a black matrix layer, disposed on the lower surface of the second substrate;
an over coat layer, disposed between the black matrix layer and the plurality of spacers, wherein the black matrix layer and the over coat layer are located in the display region, the non-display region and the peripheral region; and
a color filter layer, disposed between the black matrix layer and the over coat layer and at least located in the display region.

8. The display panel according to claim 6, wherein each of the plurality of spacers comprises a main spacer and a sub spacer disposed with a space from each main spacer, wherein the main spacer has a first height protruding from the second substrate toward one side of the first substrate, the sub spacer has a second height protruding from the second substrate toward the one side of the first substrate, and the first height is greater than the second height.

9. The display panel according to claim 8, further comprising: a first color filter layer located in the non-display region and the peripheral region, the sub spacer comprising a first sub spacer and a second sub spacer, and the first sub spacer being disposed corresponding to the first color filter layer, wherein a first vertical distance is between an end of the main spacer and an upper surface of the first substrate which is relatively close to the second substrate, a second vertical distance is between and an end of the first sub spacer and the upper surface, a third vertical distance is between an end of the second sub spacer and the upper surface, the first vertical distance is less than the second vertical distance, and the second vertical distance is less than the third vertical distance.

10. The display panel according to claim 8, further comprising:
a pad layer, located on an upper surface of the first substrate in the non-display region and the peripheral region, the sub spacer comprising a first sub spacer and a second sub spacer, and the first sub spacer being disposed corresponding and opposite to the pad layer, wherein a first vertical distance is between an end of the main spacer and an upper surface of the first substrate which is relatively close to the second substrate, a second vertical distance is between an end of the first sub spacer and the pad layer, a third vertical distance is between an end of the second sub spacer and the upper surface, the first vertical distance is less than the second vertical distance, and the second vertical distance is less than the third vertical distance.
